(19) United States
(12) Patent Application Publication
(10) Pub. No.: US 2021/0270077 A1
(43) Pub. Date: Sep. 2, 2021

(54) BATTERY SYSTEM FOR POWERING AN OVERHEAD DOOR OPENER

(71) Applicant: Hall Labs LLC, Provo, UT (US)

(72) Inventors: David R. Hall, Provo, UT (US); Jerome Miles, Spanish Fork, UT (US); Chris Jones, Spanish Fork, UT (US)

(73) Assignee: Hall Labs LLC, Provo, UT (US)

(21) Appl. No.: 17/190,305

(22) Filed: Mar. 2, 2021

Related U.S. Application Data
(60) Provisional application No. 62/984,111, filed on Mar. 2, 2020.

(51) Int. Cl. E05F 15/668

(52) U.S. Cl. CPC E05F 15/668; E05Y 2400/614; E05Y 2900/106

(57) ABSTRACT

A system for operating an overhead door using a battery and a low voltage power supply are disclosed. A battery is connected to a standard power outlet and charges from a power adaptor that converts the power down to a reduced voltage and provides the reduced power to the battery. The battery provides the principal power required to operate the overhead door opener. With the preferred embodiment, there is no need for an additional, higher-rated outlet near the overhead door opener, or a long high-voltage cable in the garage.

### CROSS-REFERENCE TO RELATED APPLICATIONS

This application claims priority to U.S. Provisional Patent Application No. 62/984,111 entitled “SYSTEM AND METHOD FOR POWERING AN OVERHEAD DOOR” filed Mar. 2, 2020, which is incorporated herein by reference in its entirety.

### TECHNICAL FIELD

The present disclosure is directed to apparatuses, systems, and methods for raising and lowering an overhead door.

### BACKGROUND

This invention relates to systems and methods for raising and lowering overhead door such as a garage door, commercial door, roller door, or loading doors, etc. Current garage door openers require a 110/220v AC power outlet to provide sufficient power to raise and lower the door. In nearly all cases, this requires a separate outlet near the garage door opener which is costly and inefficient. The specialized outlet must be near the machine because regulations limit the length of cord that can carry this power to the machine. There is a need in the art for an improved garage door opener.

### SUMMARY

Embodiments of the present disclosure are directed to a battery system for principal power to an overhead door opener. The system includes a first cable connected to a standard power outlet, and a power adapter coupled to the first cable and being configured to convert power from the standard outlet to a low voltage. The system also includes a second cable coupled to the power adapter, and a battery coupled to the second cable. The battery is configured to charge on the low voltage, and to provide power to a motor unit. The motor unit is operable to raise and lower an overhead door.

Further embodiments of the present disclosure are directed to a method for operating an overhead door opener using a battery as a principal power source. The method includes connecting a power adaptor to a 120 volt outlet, converting power from the 120 volt outlet to a low voltage by a power adaptor, and conveying the low voltage from the power adaptor to a battery. An entire length of cabling and power outlet combined is at least 10 feet in length between the 120 volt outlet and the battery. The method also includes charging the battery using the low voltage, and in response to a signal to operate the overhead door opener, using power from the battery to operate the overhead door opener.

Still further embodiments of the present disclosure are directed to a system for operating an overhead door opener including a cable longer than 10 feet in length configured to plug into a 120 volt outlet, and a power adaptor on the cable being configured to convert the power from the 120 volt outlet to a low voltage. The system also includes a battery configured to charge from the low voltage from the cable. The battery is configured to operate an overhead door opener using only the power received from the low voltage power adaptor. Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a front view of an overhead door according to embodiments of the present disclosure.

FIG. 2 shows the overhead door in a lifted state with the spools wound up and the cables wound up to raise the overhead door.

FIG. 3 shows a garage door opener according to the prior art.

FIG. 4 is a schematic view of an overhead door system according to embodiments of the present disclosure.

FIG. 5 is a chart of power against time according to embodiments of the present disclosure.

FIG. 6 is a chart of total available charge in the battery over time according to embodiments of the present disclosure.

FIG. 7 is a block diagram of a method of operating a battery and charging system according to embodiments of the present disclosure.

### DETAILED DESCRIPTION

The following description recites various aspects and embodiments of the present disclosure. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the terms “standard outlet” and “standard power outlet” are used to refer to power outlets providing a voltage that is standard in the country where they are found. For example, a standard voltage in the United States is 110 V. In much of Europe a standard voltage is 220V. The term “battery” refers to at least one rechargeable cell. For convenience, the term “battery” also includes the charging circuitry needed to recharge the battery. “Low voltage” is defined herein according to the National Electrical Code (NEC) as not greater than 30 root mean square, 42 peak, or 60 volts dc power. Low voltage is sufficiently low that contacting a cable carrying low voltage does not cause harm such as shock, burns, or electrocution.

As used herein, the term “principal,” as used in “principal power” means that the battery provides the major source of power for the overhead door opener. For example, the low power cable may also provide power to the opener, but the bulk of the power to run the motor on the door opener comes from the battery. Naturally, this phrase “principal power” is not referring to counterbalance systems, such as the torsion springs often used on garage doors.

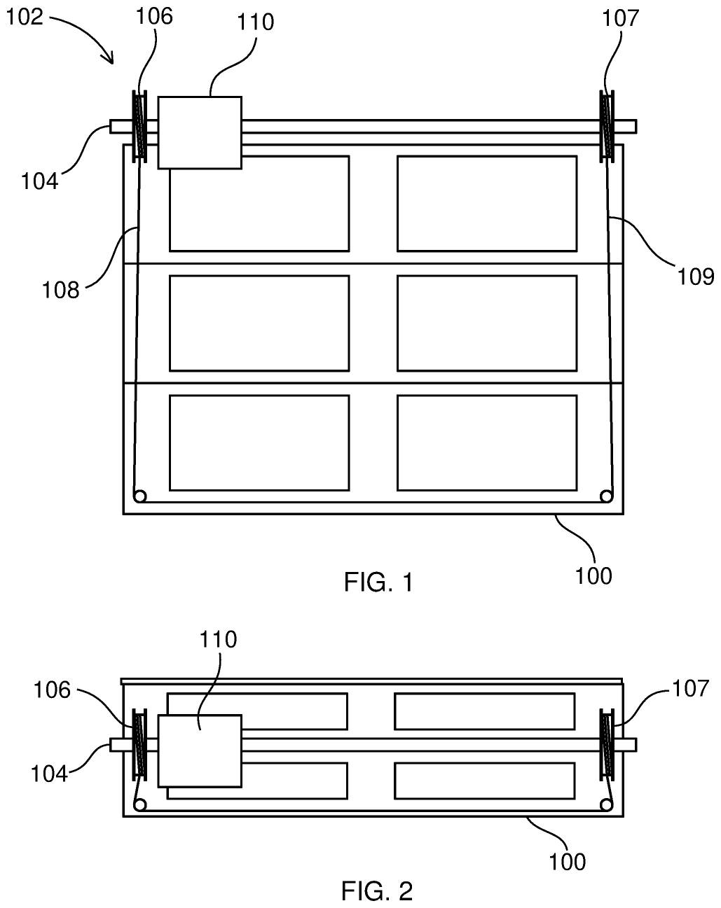

FIG. 1 is a front view of an overhead door 100 according to embodiments of the present disclosure. Many homes have overhead doors that are used to enter a garage. Many residential overhead doors are used for automobiles and are opened via a remote control in the car and in the garage to open and close the overhead door. The overhead door 100 of the present disclosure is coupled to an opener 102 which includes a shaft 104, spools 106 and 107 at either end of the shaft 104, and cables 108 and 109 that connect to the spools and to the overhead door 100. A motor unit 110 is coupled to the shaft 104 and turns the shaft 104 which turns the spools 106, 107 and winds the cables 108, 109 onto and off of the spools 106, 107 to raise and lower the overhead door 100, respectively. In some embodiments the cables are a single cable that extends from one spool 106 to the overhead door 100 and along the lower edge and up to the other spool 107. In other embodiments there can be a single spool on one side of the shaft 104. In still further embodiments the spool is centrally located and the motor unit 110 winds the spool from the center of the overhead door 100.

In some embodiments the motor unit 110 is directly coupled to the shaft 104 to rotate the shaft 104 to operate the overhead door. In other embodiments the motor unit 110 is coupled to a belt drive or other mechanical system used to raise and lower the overhead door 100.

FIG. 2 shows the overhead door 100 in a lifted state with the spools 106, 107 wound up and the cables 108, 109 wound up to raise the overhead door 100. The overhead door 100 can be raised and lowered in response to a signal from a remote or a hard-wired control inside the garage or outside the garage.

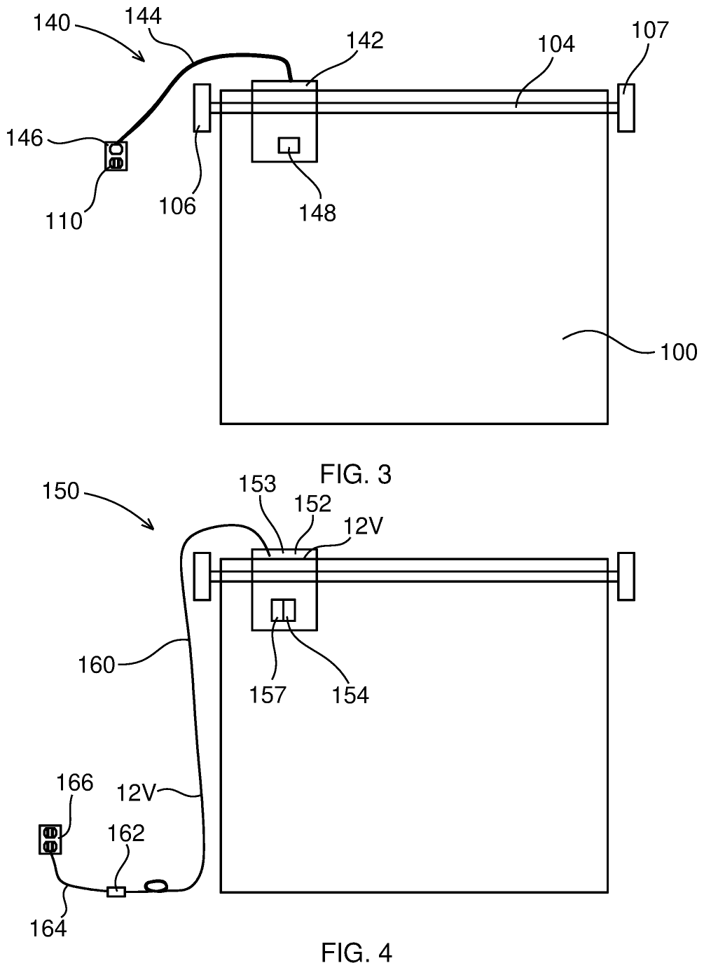

FIG. 3 shows a garage door opener 140 according to the prior art. The opener 142 includes a motor unit 142, a cable 144, and an outlet 146. The outlet 146 provides 110/220v AC power as required by many regulations and standards-setting bodies such as UNDERWRITERS LABORATORIES™. According to these regulations, the cord 144 carrying this amount of power cannot be longer than a specified amount in a residential building. As a result, the garage door opener must be placed near the outlet to comply with the building codes.

Many such systems include a backup battery 148 that is used when there is a power outage or other failure. These batteries may go unused for long periods of time, and many of them will never discharge any power. It is impossible to know whether or not the battery is in working order or not. In the event of a failure, the battery may not work at all, it may have lost its charge, or any number of things can go wrong and without a system in place to be sure it is working, it is an unknown quantity.

FIG. 4 is a schematic view of an overhead door system 150 according to embodiments of the present disclosure. The system 150 includes a motor unit 152 coupled to a shaft 104 of an overhead door 100. The motor unit 152 includes a battery 154 that is the principal source of power for the motor unit 152. When the motor unit 152 is called upon to raise or lower the overhead door 100, or to discharge any power whatsoever such as a light or a communication module on the motor unit 152, the power comes from the battery 154. The battery 154 and motor unit 152 operate on a low voltage. The outlet provides power at 120 volts, but this voltage level is reduced by the systems and methods of the present disclosure to a lower, low voltage that can be transmitted over a longer cable, enabling distant placement of the motor unit 152 from the outlet. The low voltage can be 12 volts, 24 volts, or any other suitable low voltage less than the 120 v standard, and low enough to be transmitted over a cable longer than ten feet.

The system 150 further includes a first cable 160, a power adapter 162, and a second cable 164. The power adapter 162 is configured to convert from 110/220 AC down to a low voltage. The low voltage can be 12 volts, 18 volts, 20 volts, or any other commercially useful voltage. The low voltage can be lower than the 120 volts, and in some cases significantly lower. The low voltage can also be less than what is required by most commercial garage door openers on the market today. Using the low voltage allows for a longer cord to be used, which allows a more distant placement of the motor unit 152 relative to the outlet.

The second cable 164 connects the power adapter 162 to an outlet 166. The first cable 160 connects the power adapter 162 to the battery 154. Because the first cable 160 is a low voltage, such as 12 volts, and not a higher voltage/power rating, it is allowed by most applicable regulations to be long enough to reach a standard outlet in a house or in the garage. Building codes and standards such as UL 325 specify a length of cord that is not to be exceeded in residential buildings. The system 150 complies with this standard without requiring an outlet to be built into the house near enough to the motor unit 152 to comply with UL 325 because the cable 164 is a low voltage cable, and not the 110/220 AC cable as shown in FIG. 3 of the prior art. The power adapter also preferably converts AC (alternating current) to DC (direct current). The power supplied to the battery 154 is “low voltage” power as defined by the National Electrical Code as not greater than 30 volts root mean square (rms), 42 volts peak, or 60 volts dc. In other embodiments, the voltage supplied to the battery is sufficiently low that contacting the cable will not cause shock, electrocution, burning, or any other significant damage.

The systems and methods of the present disclosure provide the massive benefit of not having to install a separate, different, more powerful power outlet in a home. Also, the motor unit of an overhead door opener can be further away from the outlet. The location of the power outlet is another benefit. The length of the cord that is allowed by the present system is much greater than those of the prior art, allowing for different power outlets to be used if one becomes unusable, and without violating a building code and running a long cable carrying high voltage in a residential garage.

The battery 154 can be charged using a trickle charge from the power adapter 162 over relatively long stretches of time where the motor unit 152 is not in use, so that the battery 154 has sufficient power to raise and lower the overhead door 100 on demand. The size and capacity of the battery 154 can be chosen according to an average household's use of an overhead door 100. In some embodiments the battery 154 can be large enough to cycle the overhead door 100 three times in one minute. A cycle defined as once up, once down. A half cycle can be defined as once up, or once down. An up-cycle can be defined as lifting the overhead door up one time, and a down-cycle can be defined as lowering the overhead door one time. Partial cycles are also possible, such as when the overhead door is prevented from completing a full up or down-cycle, and the overhead door is returned to a raised or lowered position.

The system 150 can also include a secondary battery 157 configured to operate in a generally similar manner as the battery 154. The secondary battery 157 can operate alternatingly with the battery 154. In other embodiments the secondary battery 157 is a backup battery that is used only when the battery 154 fails or has insufficient charge.

The system 150 preferably also includes a controller 153 configured to execute controls for the battery to determine how and when to charge the battery. The controller 153 can calculate an expected load, a usual cycle, timings of cycles, and other factors that can be used to determine when to charge the battery, and a rate of charge to employ. The controller 153 can also be configured to issue an alarm if there is any problem with the system 150 such as insufficient power in the battery 154 or battery 157. The controller 153 can determine a time period to wait before charging the battery 154 or secondary battery 157. For example, the controller 153 can determine that no load will be present for at least three hours, and it takes two hours to reach sufficient charge, so it can wait at least one hour to begin the charge. In other embodiments the controller 153 can charge the batteries steadily and stop charging when there is sufficient power in the batteries to execute one or more cycles. The number of cycles can be one, two, or any other suitable number of cycles.

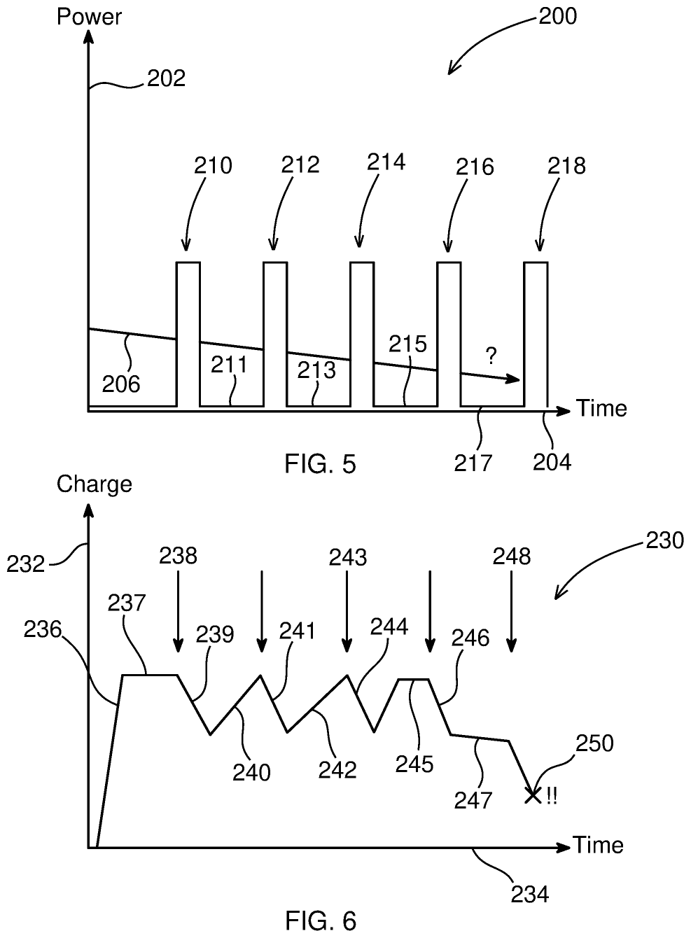

FIG. 5 is a chart 200 of power against time according to embodiments of the present disclosure. Power is at the vertical axis 202, and time is at the horizontal axis 204. Backup batteries of the prior art are seldom, if ever, used. The level of charge available in a backup battery 206 is an unknown. Without regular use, or a monitor installed, there is no reliable way to check whether or not the backup battery will have any charge. It is reasonable to suppose that the backup battery will steadily decline in charge as shown here at 206. When the time comes for the backup battery to kick in, it may or may not have sufficient power to do the job. Alternatively, the system of the present disclosure uses the battery to raise and lower the overhead door, and it charges in between uses. The chart 200 shows power output from the battery according to the present disclosure. When the overhead door opener is activated, power output spikes at 210 and stays there for the duration of the cycle or half cycle, then drops back down at 211. Each cycle in the chart 200 has a spike and a trough between when power is not used. The spikes 212, 214, 216, and 218 need not be the same level, and in fact if there is insufficient power when called for, the operator will know of the fact immediately, without any monitoring hardware or software dedicated to the task.

FIG. 6 is a chart 230 of total available charge in the battery over time according to embodiments of the present disclosure. Charge is at the vertical axis 232, and time is at the horizontal axis 234. Initially the battery is charged at 236. This initial charge can be executed during manufacturing, or upon installation. There is a max level of charge in the battery at 237, and the battery stays at this level, excluding some natural decay, until called upon to deliver power to the motor. At 238 the overhead door is opened, and the battery delivers power to execute the cycle. Power level declines as it is drained from the battery at 239. When the cycle is complete, at 240 the battery begins to trickle charge again. The rate of trickle charge can depend on rate of usage based on usage patterns and can be adjustable as described in more detail below.

At 241 another cycle is initiated and the battery drains until completing at 242 at which point it is charged once again. The same process can be repeated at 243 and 244. The slopes of each of these charge and depletion regions can vary. The slope of the depletion profiles (239, 241, and 244) depend on the amount of work done by the door. Mostly, cycles are either up or down, and up will generally require more power. Usually the door itself is the only load and the weight is constant; however, if the weight is increased such as by snow or ice stuck to the door, or by a child hanging inadvisably from the door as it raises, the weight is not necessarily constant.

The slope of the replenishing regions (240 and 242) can be controlled by the battery which can pull more or less power to reach a required power level before being called on to execute a cycle. Sometimes, such as at 245, the battery reaches full capacity and stays there for some period of time. This period of full charge is referred to as “full charge status.” The length of time the full charge status lasts can be a factor in determining the rate of charge for the battery. The replenish rate need not be as high as it possibly could be if there will be a lengthy full charge status period afterward. In some embodiments the battery does not charge between each and every cycle. At 246 the battery is called upon to execute a cycle, and at 247 it is left where it is, at approximately ⅔^{rd} charged. This is based on a calculation that cycles are not consuming so much of the available power that the battery needs to charge every time. Another cycle is called upon at 248, and executed. There can be any number of cycles, and the number available between charge times depends on the load on the system and the battery capacity.

At 250 the battery is depleted, and an error occurs. The error may have any number of causes, but since the battery is used for each cycle, the error is known as it happens, and will not be allowed to persist for a lengthy time period, and only show up when the battery is the only available source of power such as during a power outage or the like.

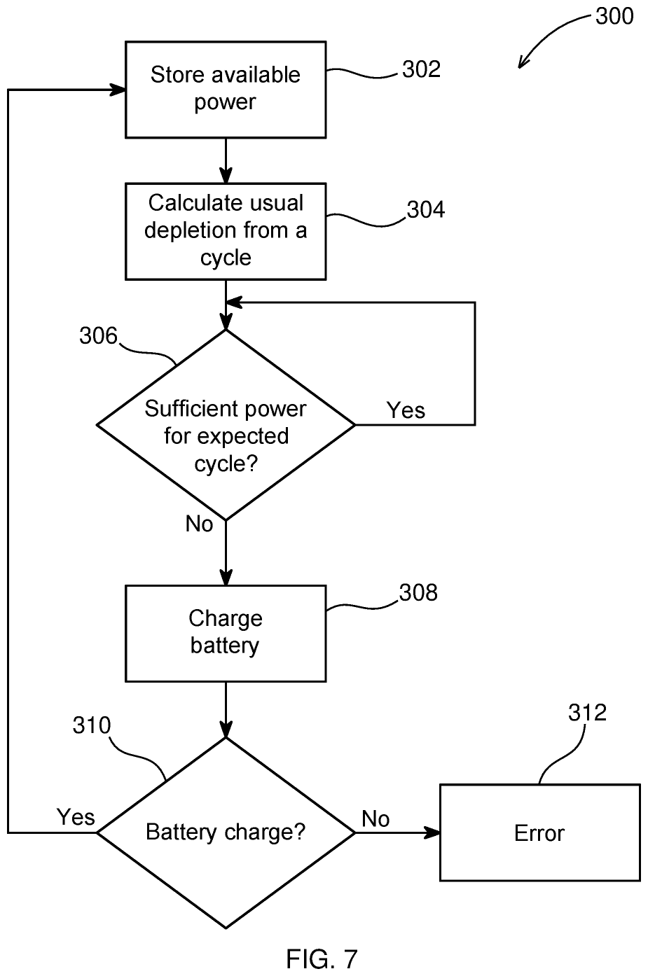

FIG. 7 is a block diagram of a method of operating a battery and charging system according to embodiments of the present disclosure. At 302 the system is idle and an amount of available power is stored in memory. At 304 a usual depletion amount is calculated. The usual depletion is the quantity of power required during a cycle. The cycle can be defined as however the unit is used. Most overhead doors are opened for a vehicle to enter, after which it is closed, defining one cycle. Other uses are also possible, and the system can adjust. Calculating the usual cycle can be done by a processor on board a garage door opener, or the calculations can be done remotely by another computing device and the results transmitted to the local device.

At 306 a check is performed to see whether or not there is sufficient power to handle the load for an expected cycle. If there is, the check can continue every second or so or however often is convenient for the system. The check can be once per minute, or once per hour, or any desired time length. If there is insufficient power in the battery to meet the demand for an expected cycle, at 308 the battery is charged. The system can include a built-in buffer region, to never let the amount of charge deplete lower than, say, 10% of the available charge. The buffer region amount can vary greatly depending on usage. In some embodiments the buffer region amount is at least approximately equal to the power required for a single cycle. This way the battery will never have less than one full cycle's worth of power.

At 310 a check is performed to see whether or not the battery has reached a desired level of charge. The desired level of charge can be full, near full, or it can be relative to a single cycle worth of power. There may be two or more levels of acceptable charge: one at full, and another at greater than one cycle's worth of power. If the battery cannot be charged sufficiently, at 312 an error occurs. The error can be a signal sent to a remote device such as a smartphone, or a server, or it can simply mean the system will have insufficient power and will therefore be unable to execute a cycle.

The foregoing disclosure hereby enables a person of ordinary skill in the art to make and use the disclosed systems without undue experimentation. Certain examples are given to for purposes of explanation and are not given in a limiting manner. All patents and published patent applications referred to herein are incorporated herein by reference.

1. A battery system for powering an overhead door opener, comprising:
a first cable connected to a power outlet;
a power adapter coupled to the first cable and being configured to convert power from the standard power outlet to a low voltage;
a second cable coupled to the power adapter;
a battery coupled to the second cable, wherein the battery is configured to charge on the low voltage, and to provide power to the overhead door opener, wherein the overhead door opener is operable to raise and lower an overhead door.

2. The battery system of claim 1 wherein the second cable is greater than 10 feet in length.

3. The battery system of claim 1 wherein the low voltage is not greater than 30 rms, 42 peak, or 60 volts dc power.

4. The battery system of claim 1, further comprising a control module configured to direct the battery when to charge.

5. The battery system of claim 4 wherein the control module is configured to:
calculate an available power in the battery;
calculate a usual depletion from a cycle, wherein the depletion comprises an amount of charge required of the battery during raising or lowering of the overhead door;
if there is insufficient power in the battery for an expected power load according to a predetermined threshold, charge the battery; otherwise, wait to charge the battery.

6. The battery system of claim 5, wherein wait to charge the battery comprises waiting at least one hour to charge the battery.

7. The battery system of claim 5, wherein wait to charge the battery comprises waiting until the overhead door is raised or lowered before charging the battery.

8. The battery system of claim 1, further comprising an alarm system configured to issue an alarm if the battery has insufficient charge to raise or lower the overhead door.

9. The battery system of claim 1, further comprising a secondary battery configured to back up the battery, wherein the secondary battery and battery operate alternatingly.

10. A method for operating an overhead door opener using a battery as a principal power source, comprising:
connecting a power adaptor to a standard outlet;
converting power from the standard outlet to a low voltage in a power adaptor;
conveying the low voltage from the power adaptor to a battery, wherein an entire length of cabling and power outlet combined is at least 10 feet in length between the standard outlet and the battery;
charging the battery using the low voltage;
in response to a signal to operate the overhead door opener, using power from the battery to operate the overhead door opener.

11. The method of claim 10, further comprising:
determining a usual load on the overhead door opener;
calculating an available charge in the battery;
if the battery has insufficient power to operate the overhead door for a predetermined number of operations, charging the battery from the low voltage.

12. The method of claim 11 wherein the predetermined number of operations is one.

13. The method of claim 11 wherein the operations comprise at least one of raising and lowering the overhead door.

14. The method of claim 10, further comprising issuing an alarm if there is insufficient power in the battery to operate the overhead door opener.

15. A system for operating an overhead door opener, comprising:
a cable longer than 10 feet in length configured to plug into a 120 volt outlet;
a power adaptor on the cable being configured to convert the power from the 120 volt outlet to a low voltage not greater than 30 root mean square voltage, 42 peak voltage, or 60 volts dc;
a battery configured to charge from the low voltage from the cable, wherein the battery is configured to operate an overhead door opener using only the power received from the low voltage from the power adaptor.

16. The system of claim 15, further comprising a controller configured to determine whether or not to charge the battery.

17. The system of claim 15 wherein the battery is configured to store enough power for at least two cycles of the overhead door opener, wherein a cycle comprises raising the overhead door one time and lowering the overhead door one time.

18. The system of claim 15, further comprising a secondary battery also configured to receive power from the power adaptor, and wherein the secondary battery operates alternatingly with the battery.

19. The system of claim 18 wherein if there is insufficient power in the battery to operate the overhead door opener, the system is configured to issue an alarm.

20. The system of claim 15 wherein the low voltage is sufficiently low that contacting the cable will not cause electrocution, burns, or shock.
